(19) United States
(12) Patent Application Publication
(10) Pub. No.: US 2026/0220794 A1
(43) Pub. Date: Jul. 30, 2026

(54) BITRATE ADAPTATION FOR EDGE-ASSISTED LOCALIZATION BASED ON MAP AVAILABILITY FOR MOBILE DEVICES

(71) Applicant: TELEFONAKTIEBOLAGET LM ERICSSON (PUBL), STOCKHOLM (SE)

(72) Inventors: José Araújo, Stockholm (SE); Yakov Teplitsky, Cupertino, CA (US); Per-Erik Brodin, Scotts Valley, CA (US); André Mateus, Uppsala (SE); Paula Carbó Cubero, Stockholm (SE)

(21) Appl. No.: 19/142,618

(22) PCT Filed: Dec. 23, 2022
(86) PCT No.: PCT/US2022/053974

§ 371 Date: Jun. 23, 2025

(51) Int. Cl. G06T 7/246; G06T 7/579; G06T 7/73; G06T 9/00; G06V 10/40; G06V 10/75

(52) U.S. Cl. CPC G06T 7/248; G06T 7/579; G06T 7/74; G06T 9/00; G06V 10/40; G06V 10/75; G06T 2207/10016; G06T 2207/30241; G06T 2207/30244

(57) ABSTRACT

The present disclosure provides an adaptive compression system performed by a mobile device for image data to be sent to an edge device that takes into consideration the presence and/or bitrate of any maps of the environment. In an embodiment, the mobile device can determine whether image data associated with an image of an environment corresponds to at least a portion of a map of the environment and determine a first bitrate of the map. The mobile device can, in response to determining that the image data matches at least a portion of the map of the environment, encode the image data, where a second bitrate of the encoded image data is selected based on whether there is a corresponding map and on the first bitrate of the map. The mobile device can then transmit the encoded image data to a network node.

### TECHNICAL FIELD

The present disclosure relates to Simultaneous Localization and Mapping (SLAM) for a mobile device and, more specifically, server, or edge, assisted SLAM.

### BACKGROUND

Simultaneous localization and mapping (SLAM) is a technique used by robots and autonomous vehicles to build a map of their surroundings while simultaneously keeping track of their own location within that map. This allows the robot or vehicle to navigate its environment in a more intelligent and efficient way, using the map it has built to plan its movements and avoid obstacles. SLAM algorithms typically combine data from a variety of sensors, such as cameras, lidar, and odometry, to create a consistent and accurate map of the environment.

SLAM algorithms are energy intensive however, and there are benefits to offloading localization and mapping algorithms to from the device to a server such as an edge device or cloud server. This can greatly increase the device battery lifetime even when considering the cost of streaming raw sensor data to the edge/cloud in real-time. However, such streaming imposes a heavy demand on the network. Image data and other raw sensor data can be compressed to ease the bandwidth constraints, but there are tradeoffs with respect to performance of localization and mapping. By performance of the localization, this can refer to the accuracy of the localization, but also to the latency of localization, which if the device is moving, can also impact the accuracy of the localization.

### SUMMARY

The present disclosure provides an adaptive compression system performed by a mobile device for image data to be sent to an edge device that takes into consideration the presence and/or bitrate of any maps of the environment. In an embodiment, the mobile device can determine whether image data associated with an image of an environment corresponds to at least a portion of a map of the environment. The mobile device can also determine a first bitrate of the map of the environment. The mobile device can, in response to determining that the image data matches at least a portion of the map of the environment, encode the image data into compressed image data, wherein a second bitrate of the compressed image data is less than or equal to a first bitrate of the map of the environment. The mobile device can also, in response to determining that the image data does not match at least a portion of the map of the environment, encode the image data resulting in encoded image data, wherein a third bitrate of the encoded image data is higher than or equal to the second bitrate of the compressed image data. The mobile device can then, transmit, either the compressed image data or the encoded image data to a network node.

In another embodiment, a mobile device can be configured to compress image data for simultaneous localization and mapping. The mobile device can include a radio interface and processing circuitry that can be configured to determine whether image data associated with an image of an environment matches at least a portion of a map of the environment. The processing circuitry can also be configured to determine a first bitrate of the map of the environment. The processing circuitry can also be configured to in response to determining that the image data matches at least a portion of the map of the environment, encode the image data resulting in compressed image data, wherein a second bitrate of the compressed image data is less than or equal to a first bitrate of the map of the environment. The processing circuitry can also be configured to in response to determining that the image data does not match at least a portion of the map of the environment, encode the image data resulting in encoded image data, wherein a third bitrate of the encoded image data is higher than or equal to the second bitrate of the compressed image data. The processing circuitry can also be configured to transmit, at least one of the compressed image data or the encoded image data to a network node.

In another embodiment, a non-transitory computer readable medium can be provided that comprises instructions, that when executed by a processor perform operations that include determining whether image data associated with an image of an environment matches at least a portion of a map of the environment. The operations also include determining a first bitrate of the map of the environment. The operation can also include in response to determining that the image data matches at least a portion of the map of the environment, encoding the image data resulting in compressed image data, wherein a second bitrate of the compressed image data is less than or equal to a first bitrate of the map of the environment. The operations can also include in response to determining that the image data does not match at least a portion of the map of the environment, encoding the image data resulting in encoded image data, wherein a third bitrate of the encoded image data is higher than or equal to the second bitrate of the compressed image data. The operations can also include transmitting, at least one of the compressed image data or the encoded image data to a network node.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a message sequence chart for a method for compressing image data for simultaneous localization and mapping according to some embodiments of the present disclosure;

FIG. 2 illustrates one example of a cellular communications system according to some embodiments of the present disclosure;

FIG. 3 is a schematic block diagram of a network node according to some embodiments of the present disclosure;

FIG. 4 is a schematic block diagram that illustrates a virtualized embodiment of the network node of FIG. 3 according to some embodiments of the present disclosure;

FIG. 5 is a schematic block diagram of the network node of FIG. 3 according to some other embodiments of the present disclosure;

FIG. 6 is a schematic block diagram of a User Equipment (UE) device according to some embodiments of the present disclosure; and

FIG. 7 is a schematic block diagram of the UE of FIG. 6 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Mobile Device: A mobile device is any type of wireless device that has access to (i.e., is served by) a wireless network (e.g., a cellular network). Some examples of a mobile device include, but are not limited to: a User Equipment device (UE) in a Third Generation Partnership Project (3GPP) network, a Machine Type Communication (MTC) device, and an Internet of Things (IoT) device. Such devices may be, or may be integrated into, a mobile device such as, e.g., a mobile phone, smart phone, vehicle, virtual reality (VR) glasses, augmented reality (AR) glasses, robotic device, or the like, or integrated into any type of device for which localization is desired. The mobile device may be enabled to communicate voice and/or data via a wireless connection.

Network Node: As used herein, a “network node” is any node that is either part of the radio access network (RAN) or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Given the tradeoffs noted in the Background, a bitrate adaptation method is proposed for the compression of images sent by the mobile device to an edge device or server for assisted Simultaneous localization and mapping (SLAM). The bitrate adaptation method takes into consideration the 4 following observations.
1) When a map of a certain location is available and its map data has been obtained from compressed images with a given bitrate, the best localization performance is obtained when the same level of compression (same bitrate) is applied to the images which are to be used to perform localization with respect to such map. The closer the bitrates of the map and images are therefore, the better the localization will be.
2) When a map of a certain location is available and its map data has been obtained from compressed images with a large bitrate, a small performance degradation occurs when a large level of compression (small bitrate) is applied which are to be used to perform localization with respect to such map. Therefore, if a map is of high quality, it is still possible to localize with good quality on such map even if the images are of lower quality.
3) When a map of a certain location is available and its map data has been obtained from highly compressed images (small bitrate), a large performance degradation occurs when a small level of compression (high bitrate) is applied to the images which are to be used to perform localization with respect to such map. Therefore, if a map is of low quality, the localization performance is degraded even if high quality images are used to localized against the map.
4) When a map of a certain location is not available, the performance can be significantly degraded if compression is applied to the images which are used to perform the estimation of the pose (position, orientation) of the device via visual odometry algorithms (note that this is no longer the process of performing localization of the device against a map, but simply determining the pose of the device in a given coordinate system).

It is to be appreciated that in the present disclosure, while reference is made to capturing, encoding, compressing, and/or transmitting images, these images can be frames of a video stream that are encoded and compressed via a video codec such as AVC/H.264, HEVC/H.265, VVC/H.266, or similar. The video stream comprises the images at a certain rate or frames per second, and with a bitrate that is controlled by the video codec. Alternatively, the images can be individual images that are not part of a video stream, but are individually encoded and/or compressed to a certain size, where the bitrate of the encoded and/or compressed images corresponds to a function of the size of the images and the rate at which the images are transmitted.

Based on these observations, the present disclosure provides an adaptive compression system performed by a mobile device for image data to be sent to an edge device that takes into consideration the presence and/or bitrate of any maps of the environment. In an embodiment, the mobile device can determine whether image data associated with an image of an environment corresponds to at least a portion of a map of the environment. The mobile device can also 25 determine a first bitrate of the map of the environment. In an embodiment, the first bitrate of the map of the environment can correspond to the bitrate of the images used to generate the map of the environment. The mobile device can, in response to determining that the image data matches at least a portion of the map of the environment, encode the image data into compressed image data, wherein a second bitrate of the compressed image data is less than or equal to a first bitrate of the map of the environment. The mobile device can also, in response to determining that the image data does not match at least a portion of the map of the environment, encoding the image data resulting in encoded image data, wherein a third bitrate of the encoded image data is higher than or equal to the second bitrate of the compressed image data. The mobile device can then, transmit, either the compressed image data or the encoded image data to a network node. The network node itself can perform the SLAM, and in other embodiments, network node can forward to the image data to another server to perform the SLAM.

The methods and system disclosed herein determine what should be the compression level of a stream of images captured at a device and being transmitted to a server to perform localization of the device based on a map, in order to minimize the localization performance degradation. The determination of the compression level depends on the properties of the map. In particular, the compression level of an image depends if the contents of such image are already present in the map, but also what was the compression level used to create such map elements.

An advantage of the technique disclosed herein is that images that are to be transmitted over a network can be compressed at an optimal compression rate that minimizes the localization performance degradation while also reducing network bandwidth utilized. In this way, the data traffic can be reduced when performing server-assisted localization of a device.

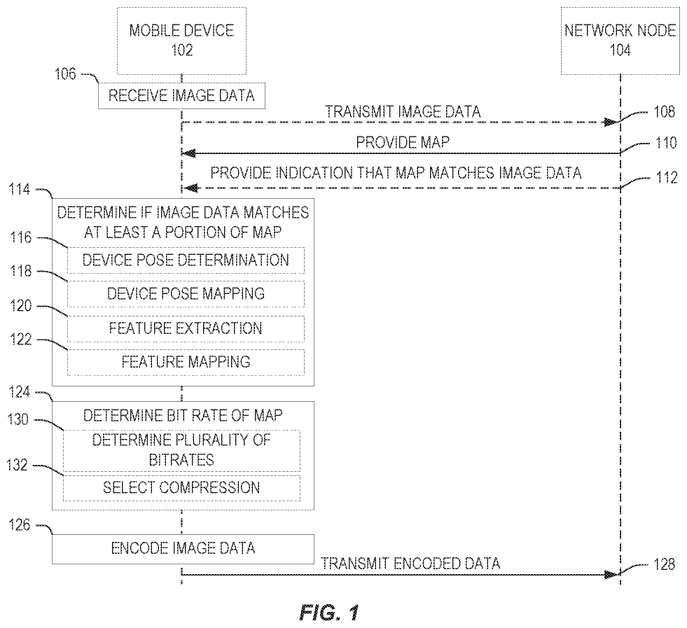

FIG. 1 illustrates a message sequence chart for a method for compressing image data for simultaneous localization and mapping according to some embodiments of the present disclosure. The message sequence chart describes the operations and transmissions of data between a mobile device 102 and a network node 104.

At step 106, the mobile device 102, can receive image data from an image sensor, where the image data represents an image of an environment around the mobile device 102. In an embodiment, the mobile device 102 can have the image sensor built into the mobile device 102. In other embodiments, the image sensor can be attached to, or otherwise be communicably coupled to the mobile device 102. The image sensor could be digital cameras such as one or more of charge-coupled device (CCD) sensors or complementary metal-oxide-semiconductor (CMOS) sensors, or other device types. The image sensor could also be in the form of a lidar or radar detector, or ultrasound sensor, or any other sensor system that can identify objects, obstacles, and other features of an environment.

In an optional step 108, the mobile device 102 can transfer the image data to the network node. The image data can be compressed at some predefined compression level, or can be uncompressed. The image data transferred at optional step 108 can be used by the network node 104 to determine whether there is any image data that corresponds to a device pose of the mobile device 102 for which a map is available, where from said device pose the device is expected to find matches between at least parts of the image data and the available map. In response to optional step 108, the network node 104 can optionally provide an indication to the mobile device 102 at step 112 that there is some device pose of the mobile device 102 for which there is match to the map.

At step 110, the network node 104 can provide a map to the mobile device 102. It is to be appreciated that while step 110 is depicted in FIG. 1 as occurring after the mobile device 102 receives the image data at step 106, in one or more embodiments, the mobile device 102 can receive the map from the network node 104 prior to receiving the image data.

The map provided by the network node 104 can be some representation of an environment that enables the location and orientation of a device (e.g., mobile device 102) to be determined based on sensor data from the mobile device 102. In traditional cases, the map would be used by the mobile device 102 to perform the localization, but in the embodiments disclosed herein, the mobile device 102 can use the map to determine if there is image data that corresponds to a device pose, and to use the device pose to find matches at step 114 between at least parts of the image data and the available map of the environment.

For example, one optional means by which the mobile device 102 can determine whether the image data matches at least a portion of the map environment can be by determining, at step 116, a device pose of the mobile device 102 with respect to the environment, and then determining, at step 118 that a portion of the map of the environment is within a field of view associated with the device pose. Device pose includes both a translational position of the device, as well as a rotational position, and can be used to determine a position an orientation of a device with respect to a field coordinate system. The mobile device 102 can determine that the portion of the map of the environment is within a field of view associated with the device by comparing features in the image to features in the map. This reachability step also considers occlusions in the map, where to determine the field of view of the captured image only the closest map elements are utilized (which is a process typically done by performing this determination on the “signed distance function” representation of the map).

The optional feature extraction step at 120 can extract a plurality of image features from the image data. The feature mapping at step 122 can then match a plurality of image features of the extracted image features to a plurality of map features extracted from the map of the environment. In an embodiment, there could be a predefined minimum number of features that match for the mobile device 102 to determine that the image data matches the map. This feature mapping provides robust determination that there is a match between the image data and the map received from the network node 104.

In an embodiment, the feature mapping at step 122 and device pose mapping 118 can be performed in a predictive manner, where instead of determining matching for a single image, it can be determined for the future sequence of images along a future path given that one is able to determine the trajectory (position, orientation) that the device will take in the map within a future time period. The number of future sequence of images to be considered can be an adjustable parameter, as for example the next 100 images which if the camera is acquiring images at 20 frames per second it would comprise the next 5 seconds of motion of the device along a future predicted path of motion.

Alternatively, as briefly mentioned above, with regard to optional step 112, the server, (either the network node 104, or some other edge device, or server) can determine the location of the mobile device 102 in a map given the image received at optional step 108 and informs the mobile device 102 at step 112 if its current pose corresponds to a device pose for which map elements of the available map will likely be captured. This is a more lightweight operation which would not require the mobile device 102 to execute feature matching. If the server has not yet received any image from the mobile device, then the mobile device 102 sends at least one image to the server so that the server can perform the determination of the mobile device 102 location and so the at least one image would be only slightly compressed or not compressed at all, in other words, with a high bitrate. The server is then able to perform the estimation of the mobile device 102 location at the current time step k based on the already received images until time step k-1. This embodiment could also be implemented in a predictive manner, where instead of determining matching for a single image, it can be determined for a sequence of images along a path given that one is able to determine the trajectory (position, orientation) that the mobile device 102 will take in the map within a future time period. Such planned trajectory can also be provided by the mobile device itself or by the server, for example in the case where the mobile device is a robot with a planned trajectory to perform a planned task or the server is the one deciding the motion of the robot in order to perform a planned task. An advantage of this alternative embodiment is that since the server performs the determination, the mobile device 102 does not spend energy or time performing this determination.

At step 124, the mobile device 102 can determine the first bitrate, or resolution, of the map. In an embodiment. The mobile device 102 can determine the first bitrate based on an indication of the first bitrate embedded in the map of the environment. In other embodiments, the network node 104 may separately signal to the mobile device 102 the bitrate or resolution of the map.

In an embodiment, the mobile device 102 can also determine whether the map elements in the available map for the current location of the mobile device 102 were built with a level of compression higher than a desired threshold. If the bitrate or the resolution is too low, this would mean that the mobile device 102 or the server would use corresponding images with too low of bitrates to accurately localize the mobile device 102. If the bitrate of the mobile device 102 is below this threshold, the mobile device 102 can operate as if there is no map, and thus send image data to the network node 104 with little or no compression, which can enable the server to build or rebuild the map for that location. In this way, the server can replace highly compressed map data that was used to build a map with fresh data that is compressed to a lesser degree, and with a higher resolution than the former map data.

Based on the determined bitrate of the map, and the determination that the image data matches at least a portion of the map of the environment, the mobile device can encode, at step 126, the image data resulting in compressed image data, wherein a second bitrate of the compressed image data is less than or equal to a first bitrate of the map of the environment. If the image data does not match at least a portion of the map of the environment, or the map bitrate is too low, the mobile device 102 can encode at step 126 the image data resulting in encoded image data, wherein a third bitrate of the encoded image data is higher than or equal to the second bitrate of the compressed image data.

It is to be appreciated that the terminology used in the present disclosure provides a distinction between the terms encoded image data and compressed image data. Both encoded image data and compressed image data are encoded using one of a variety of codecs that are used to encode image data, but encoded image data, as used herein, signals that no compression, or a low level of compression is applied to the image data, relative to the compression applied to the compressed image data. The bitrate of the encoded image data is thus higher than the bitrate of the compressed image data. Any suitable compression scheme and transmission protocol may be used. Some examples are H264 and Gstreamer.

In an embodiment, if there is a map available, or if there is a portion of the map that corresponds to the image data, at the encoding step 126, the mobile device 102 can encode the image data at a fixed compression level, or a fixed bitrate. In another embodiment, if there is a map available, the mobile device 102 can determine a range of bitrates (e.g., a minimum level to a maximum level) at which to encode the image data, and the mobile device 102 can select the compression level or the compressed image data bitrate dynamically from within the range, based on a function of the available network bandwidth.

According to another embodiment, the desired bitrate can be set to the same level as the bitrate used to build the map. The bitrate level of the map can be stored in the map and read by the mobile device 102 or the server can inform the mobile device 102 of the map bitrate. In such a case, each map point may have a different bitrate when originating from images compressed at different bitrates and so, the mobile device 102 could set the bitrate as the lowest bitrate of the predicted observed map points.

If a map is not available, or if there is not a portion of the map that corresponds to the image data, at the encoding step 126, the mobile device 102 can encode the image data resulting in encoded image data that is less compressed relative to the compressed image data. The compression level applied, if any, can be at a fixed rate, or can be dynamically selected from within a range of minimum and maximum bitrates based on a function of available network bandwidth.

In an optional embodiment, the mobile device 102 at step 130 can determine that the map data comprises a plurality of bitrates. Different portions of the map may have been constructed using images of a variety of resolutions, and/or bitrates. In an embodiment, the resolution can correspond to a bitrate and as the resolution changes, the bitrate changes. In other embodiments, depending on the codecs used to encode the images or video stream, for a given resolution, the bitrate of the images or video stream can vary. At step 132 therefore, the compression rate of the image data to be sent to the network node 104 can be selected based on the bitrate of the portion of the map data. In an embodiment, since performance can be improved in the SLAM process of the bitrate of the image data is equal to or less than the bitrate of the map, at step 132, the compression of the image data can be selected such that the compressed image data bitrate is equal to or below the lowest bitrate of the plurality of bitrates of the map.

Once the image data is encoded and/or compressed, the encoded or compressed image data can be transmitted at step 128 from the mobile device 102 to the network node 104. The image data may also be merged with additional compressed or non-compressed data captured at the mobile device 102 that can be used for localization and mapping purposes. For example, the mobile device 102 can also comprise an inertial measurement unit (IMU) which generates data that can also be transmitted to the network node 104.

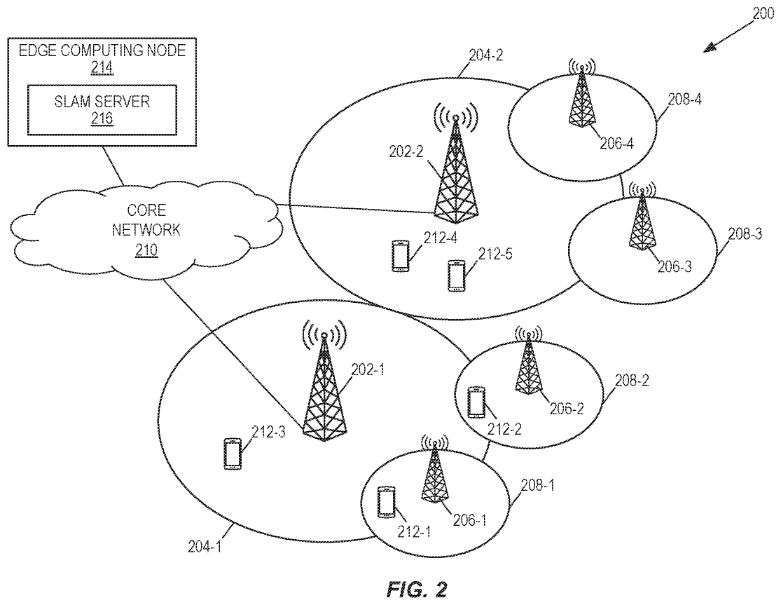

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

Any of the base stations 202, or the low power nodes 206 can be the network node 104 to which the mobile device 102 communicate and transmit encoded and/or compressed image data. The SLAM can be performed at the base stations 202 or low power nodes 206, or can alternatively the SLAM can be performed at another server such as in the core network 210 or elsewhere.

The base stations 202 and the low power nodes 206 provide service to mobile devices 212-1 through 212-5 in the corresponding cells 204 and 208. The mobile devices 212-1 through 212-5 are generally referred to herein collectively as mobile devices 212 and individually as mobile device 212. In the following description, the mobile devices 212 are oftentimes UEs, but the present disclosure is not limited thereto.

The system 200 also includes an edge computing node 214 including a SLAM server 216 where the SLAM processing of the encoded data sent to the network node 104 at step 128 can be processed. In an embodiment, as depicted in FIG. 2, the edge computing node 214 is separate from the core network 210. In other embodiments however, the edge computing node 214 and SLAM server 216 can be operable on a device within the core network 210, or even in a base station 202 or low power node 206. If the network node 104 and the edge computing node 214 are not collocated, the network node 104 can forward the encoded data to the edge computing node 214. Likewise, the edge computing node 214 can provide the map data to the network node 104 to be provided to mobile device 102.

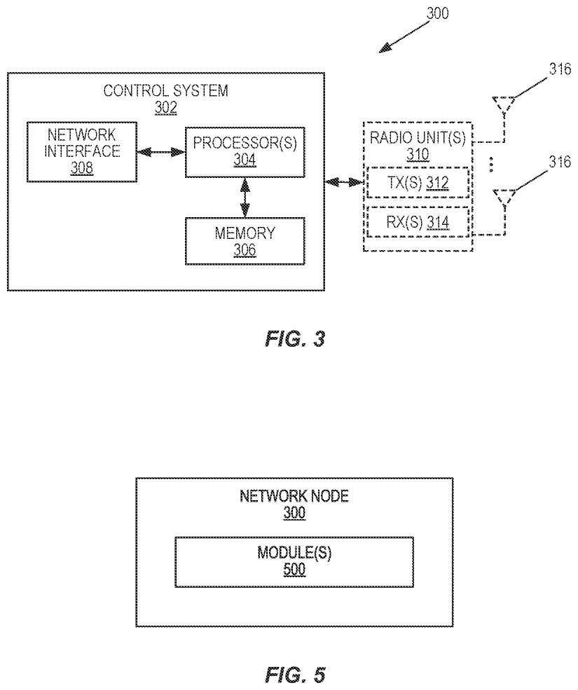

FIG. 3 is a schematic block diagram of a network node 300 according to some embodiments of the present disclosure. Optional features are represented by dashed boxes. The network node 300 may be, for example, a base station 202 or 206 or a network node that implements all or part of the functionality of the base station 202 or gNB described herein. The network node 300 can be the network node 104 that transmits map data to the mobile device 102 and receives the encoded and/or compressed image data from the mobile device 102. In some embodiments, the network node 300 can perform localization of the mobile device 102 based on the received encoded/compressed image data. As illustrated, the network node 300 includes a control system 302 that includes one or more processors 304 (e.g., Central Processing Units (CPUs), Application Specific Integrated Circuits (ASICs), Field Programmable Gate Arrays (FPGAs), and/or the like), memory 306, and a network interface 308. The one or more processors 304 are also referred to herein as processing circuitry. In addition, the network node 300 may include one or more radio units 310 that each includes one or more transmitters 312 and one or more receivers 314 coupled to one or more antennas 316. The radio units 310 may be referred to or be part of radio interface circuitry. In some embodiments, the radio unit(s) 310 is external to the control system 302 and connected to the control system 302 via, e.g., a wired connection (e.g., an optical cable). However, in some other embodiments, the radio unit(s) 310 and potentially the antenna(s) 316 are integrated together with the control system 302. The one or more processors 304 operate to provide one or more functions of a network node 300 as described herein. In some embodiments, the function(s) are implemented in software that is stored, e.g., in the memory 306 and executed by the one or more processors 304.

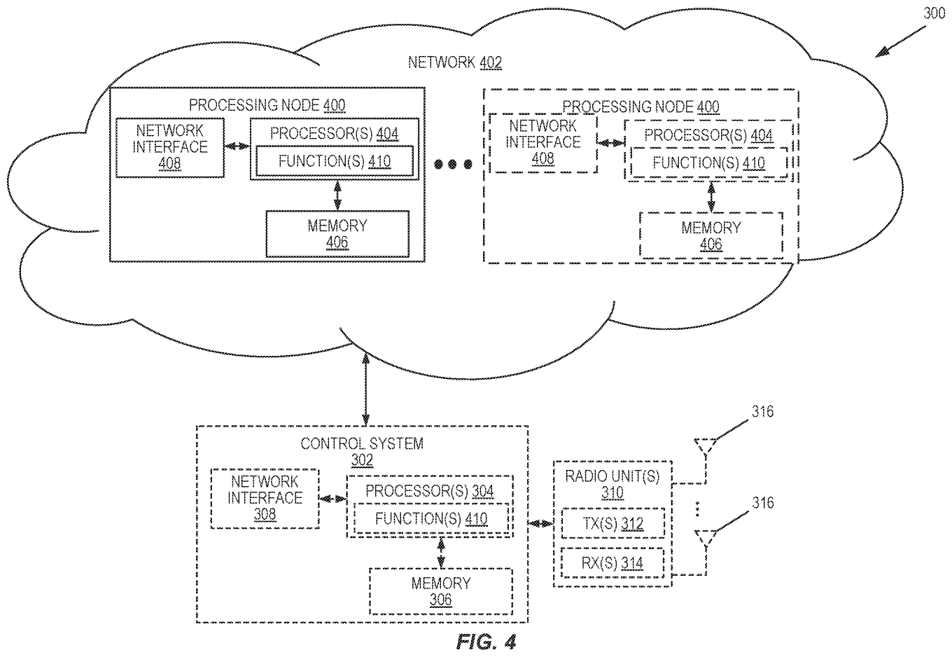

FIG. 4 is a schematic block diagram that illustrates a virtualized embodiment of the network node 300 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 300 in which at least a portion of the functionality of the network node 300 is implemented as a virtual component(s) (e.g., via a virtual machine(s) executing on a physical processing node(s) in a network(s)). As illustrated, in this example, the network node 300 may include the control system 302 and/or the one or more radio units 310, as described above. The control system 302 may be connected to the radio unit(s) 310 via, for example, an optical cable or the like. The network node 300 includes one or more processing nodes 400 coupled to or included as part of a network(s) 402. If present, the control system 302 or the radio unit(s) are connected to the processing node(s) 400 via the network 402. Each processing node 400 includes one or more processors 404 (e.g., CPUs, ASICs, FPGAs, and/or the like), memory 406, and a network interface 408.

In this example, functions 410 of the network node 300 described herein are implemented at the one or more processing nodes 400 or distributed across the one or more processing nodes 400 and the control system 302 and/or the radio unit(s) 310 in any desired manner. In some particular embodiments, some or all of the functions 410 of the network node 300 described herein are implemented as virtual components executed by one or more virtual machines implemented in a virtual environment(s) hosted by the processing node(s) 400. As will be appreciated by one of ordinary skill in the art, additional signaling or communication between the processing node(s) 400 and the control system 302 is used in order to carry out at least some of the desired functions 410. Notably, in some embodiments, the control system 302 may not be included, in which case the radio unit(s) 310 communicate directly with the processing node(s) 400 via an appropriate network interface(s).

In some embodiments, a computer program including instructions which, when executed by at least one processor, causes the at least one processor to carry out the functionality of network node 300 or a node (e.g., a processing node 400) implementing one or more of the functions 410 of the network node 300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 5 is a schematic block diagram of the network node 300 according to some other embodiments of the present disclosure. The network node 300 includes one or more modules 500, each of which is implemented in software. The module(s) 500 provide the functionality of the network node 300 described herein. This discussion is equally applicable to the processing node 400 of FIG. 4 where the modules 500 may be implemented at one of the processing nodes 400 or distributed across multiple processing nodes 400 and/or distributed across the processing node(s) 400 and the control system 302.

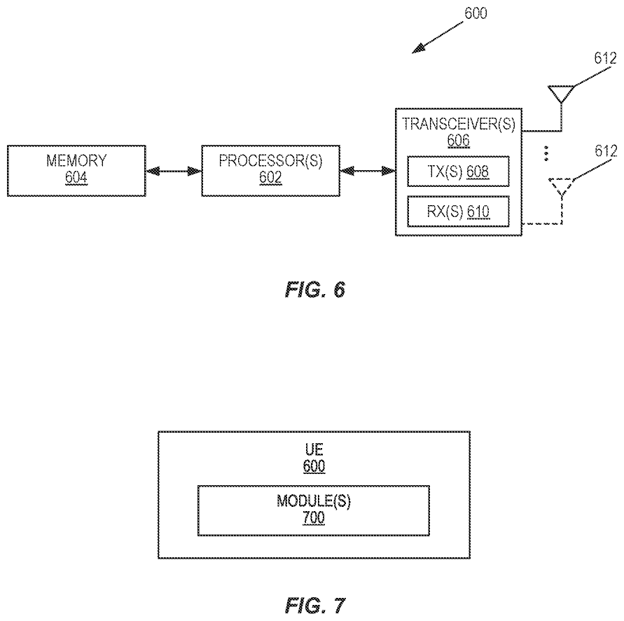

FIG. 6 is a schematic block diagram of a mobile device 600 according to some embodiments of the present disclosure. The mobile device 600 as described herein could be an example of the mobile device 102 described above. As illustrated, the mobile device 600 includes one or more processors 602 (e.g., CPUs, ASICs, FPGAs, and/or the like), memory 604, and one or more transceivers 606 each including one or more transmitters 608 and one or more receivers 610 coupled to one or more antennas 612. The transceiver(s) 606 includes radio-front end circuitry connected to the antenna(s) 612 that is configured to condition signals communicated between the antenna(s) 612 and the processor(s) 602, as will be appreciated by on of ordinary skill in the art. The processors 602 are also referred to herein as processing circuitry. The transceivers 606 are also referred to herein as radio circuitry. In some embodiments, the functionality of the mobile device 600 described above may be fully or partially implemented in software that is, e.g., stored in the memory 604 and executed by the processor(s) 602. Note that the mobile device 600 may include additional components not illustrated in FIG. 6 such as, e.g., one or more user interface components (e.g., an input/output interface including a display, buttons, a touch screen, a microphone, a speaker(s), and/or the like and/or any other components for allowing input of information into the mobile device 600 and/or allowing output of information from the mobile device 600), a power supply (e.g., a battery and associated power circuitry), etc.

In some embodiments, a computer program including instructions which, when executed by at least one processor, causes the at least one processor to carry out the functionality of the mobile device 600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the mobile device 600 according to some other embodiments of the present disclosure. The mobile device 600 includes one or more modules 700, each of which is implemented in software. The module(s) 700 provide the functionality of the mobile device 600 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AMF | Access and Mobility Function |
| AN | Access Network |
| ASIC | Application Specific Integrated Circuit |
| AUSF | Authentication Server Function |
| CCD | Charged Coupled Device |
| CMOS | Complementary Metal-Oxide-Semiconductor |
| CPU | Central Processing Unit |
| DN | Data Network |
| DSP | Digital Signal Processor |
| eNB | Enhanced or Evolved Node B |
| EPC | Evolved Packet Core |
| EPS | Evolved Packet System |
| E-UTRA | Evolved Universal Terrestrial Radio Access |
| FPGA | Field Programmable Gate Array |
| gNB | New Radio Base Station |
| gNB-DU | New Radio Base Station Distributed Unit |
| HSS | Home Subscriber Server |
| IMU | Inertial Measurement Unit |
| IoT | Internet of Things |
| LTE | Long Term Evolution |
| MME | Mobility Management Entity |
| MTC | Machine Type Communication |
| NEF | Network Exposure Function |
| NF | Network Function |
| NR | New Radio |
| NRF | Network Function Repository Function |
| NSSF | Network Slice Selection Function |
| PC | Personal Computer |
| PCF | Policy Control Function |
| P-GW | Packet Data Network Gateway |
| RAM | Random Access Memory |
| RAN | Radio Access Network |
| ROM | Read Only Memory |
| RRH | Remote Radio Head |
| SCEF | Service Capability Exposure Function |
| SLAM | Simultaneous Localization and Mapping |
| SMF | Session Management Function |
| UDM | Unified Data Management |
| UE | User Equipment |
| UPF | User Plane Function |
| WCD | Wireless Communication Device |

Those skilled in the art will recognize improvements and modifications to the embodiments of the present disclosure. All such improvements and modifications are considered within the scope of the concepts disclosed herein.

1. A method performed by a wireless communication device for compressing image data for simultaneous localization and mapping, the method comprising:
determining whether image data associated with an image of an environment corresponds to at least a portion of a map of the environment;
determining a first bitrate of the map of the environment;
in response to determining that the image data matches at least a portion of the map of the environment, encoding the image data resulting in compressed image data, wherein a second bitrate of the compressed image data is less than or equal to a first bitrate of the map of the environment;
in response to determining that the image data does not match at least a portion of the map of the environment, encoding the image data resulting in encoded image data, wherein a third bitrate of the encoded image data is higher than or equal to the second bitrate of the compressed image data; and
transmitting, at least one of the compressed image data or the encoded image data to a network node.

2. The method of claim 1, wherein the second bitrate of the compressed image data is selected based on available network bandwidth.

3. The method of claim 1, wherein the second bitrate of the compressed image data is equal to the first bitrate of a matching portion of the map of the environment.

4. The method of claim 1, wherein the second bitrate is within a predefined range of bitrates.

5. The method of claim 1, wherein determining the first bitrate of the map of the environment is based on an indication of the first bitrate embedded in the map of the environment.

6. The method of claim 1, wherein determining the first bitrate of the map of the environment is based on receiving an indication of the first bitrate of the map of the environment from the network node.

7. The method of claim 1, further comprising:
determining that the map of the environment comprises a plurality of bitrates; and
selecting the second bitrate of the compressed image data that is less than or equal to a lowest bitrate of the plurality of bitrates.

8. The method of claim 1, wherein determining whether the image data matches at least a portion of a map of the environment further comprises:
determining a device pose of the mobile device with respect to the environment; and
determining that the portion of the map of the environment is within a field of view associated with the device pose.

9. The method of claim 1, wherein determining whether the image data matches at least a portion of a map of the environment further comprises:
extracting image features from the image data; and
matching a plurality of image features of the image features to a plurality of map features extracted from the map of the environment.

10. The method of claim 9, wherein there are at least a predetermined number of matching features between the image features and map features.

11. The method of claim 9, wherein the map feature is one of a plurality of map features extracted from the map of the environment based on a trajectory of the mobile device.

12. The method of claim 1, wherein determining whether the image data matches at least a portion of a map of the environment further comprises:
receiving an indication from the network node that a device pose of the mobile device with respect to the environment matches at least the portion of the map of the environment.

13. The method of claim 1, wherein in response to the first bitrate of the map of the environment being below a predefined threshold, the third bitrate of the encoded image data is above the predefined threshold.

14. A mobile device configured to compress image data for simultaneous localization and mapping, the mobile device comprising a radio interface and processing circuitry configured to:
determine whether image data associated with an image of an environment matches at least a portion of a map of the environment;
determine a first bitrate of the map of the environment;
in response to determining that the image data matches at least a portion of the map of the environment, encode the image data resulting in compressed image data, wherein a second bitrate of the compressed image data is less than or equal to a first bitrate of the map of the environment;
in response to determining that the image data does not match at least a portion of the map of the environment, encode the image data resulting in encoded image data, wherein a third bitrate of the encoded image data is higher than or equal to the second bitrate of the compressed image data; and
transmit, at least one of the compressed image data or the encoded image data to a network node.

15. The mobile device of claim 14, wherein the second bitrate of the compressed image data is selected based on available network bandwidth.

16. The mobile device of claim 14, wherein the second bitrate of the compressed image data is equal to the first bitrate of a matching portion of the map of the environment.

17. The mobile device of claim 14, wherein the second bitrate is within a predefined range of bitrates.

18. The mobile device of claim 14, wherein determining the first bitrate of the map of the environment is based on an indication of the first bitrate embedded in the map of the environment.

19. The mobile device of claim 14, wherein determining the first bitrate of the map of the environment is based on receiving an indication of the first bitrate of the map of the environment from the network node.

20. The mobile device of claim 14, wherein the processing circuitry is further configured to:
determine that the map of the environment comprises a plurality of bitrates; and
select the second bitrate of the compressed image data that is less than or equal to a lowest bitrate of the plurality of bitrates.

21. The mobile device of claim 14, wherein the processing circuitry is further configured to:
determine a device pose of the mobile device with respect to the environment; and
determine that the portion of the map of the environment is within a field of view associated with the device pose.

22. The mobile device of claim 14, wherein the processing circuitry is further configured to:
extract image features from the image data; and
match a plurality of image features of the image features to a plurality of map features extracted from the map of the environment.

23. The mobile device of claim 22, wherein there are at least a predetermined number of matching features between the image features and map features.

24-26. (canceled)

27. A non-transitory computer readable medium comprising instructions, that when executed by a processor, perform operations comprising: determining whether image data associated with an image of an environment matches at least a portion of a map of the environment;
determining a first bitrate of the map of the environment;
in response to determining that the image data matches at least a portion of the map of the environment, encoding the image data resulting in compressed image data, wherein a second bitrate of the compressed image data is less than or equal to a first bitrate of the map of the environment;
in response to determining that the image data does not match at least a portion of the map of the environment, encoding the image data resulting in encoded image data, wherein a third bitrate of the encoded image data is higher than or equal to the second bitrate of the compressed image data; and
transmitting, at least one of the compressed image data or the encoded image data to a network node.
